(19) United States
(12) Patent Application Publication
(10) Pub. No.: US 2021/0364867 A1
(43) Pub. Date: Nov. 25, 2021

(54) ARRAY SUBSTRATE AND DISPLAY PANEL

(71) Applicant: Wuhan China Star Optoelectronics Technology Co., Ltd., Wuhan, Hubei (CN)

(72) Inventor: Guangyu Cai, Wuhan, Hubei (CN)

(21) Appl. No.: 16/603,787

(22) PCT Filed: Apr. 4, 2019
(86) PCT No.: PCT/CN2019/081488

§ 371 Date: Oct. 8, 2019

(51) Int. Cl. G02F 1/1343; G02F 1/1362

(52) U.S. Cl. CPC G02F 1/134345; G02F 1/1368; G02F 1/13624

(57) ABSTRACT

The present application provides an array substrate and a display pane. The array substrate includes a plurality of pixel units arranged in an array. Each of the pixel units includes a first pixel driving circuit, a second pixel driving circuit, and a first transparent electrode configured to drive rotation of liquid crystal molecules. The first transparent electrode includes a first electrode trace and a second electrode trace electrically insulated from each other. The first pixel driving circuit is electrically connected to the first electrode trace, and the second pixel driving circuit is electrically connected to the second electrode trace.

### BACKGROUND OF INVENTION

### 1. Field of Invention

The present invention relates to a display field, and particularly, to and an array substrate and a display panel.

### 2. Related Art

Conventional liquid crystal displays include display panels and backlight modules. A display panel is configured with a color film substrate, an array substrate, and a liquid crystal layer disposed between the color film substrate and the array substrate. A working principle of the display panel is to control rotation of liquid crystal molecules of the liquid crystal layer by applying a driving voltage, and to refract light from the backlight module to generate a picture.

Array substrates utilize semiconductor devices such as a thin-film transistor (TFT) as a switching element for pixel units to receive pixel data. In a conventional pixel unit, a pixel electrode is controlled by a pixel driving circuit. When a certain electrode line in the pixel electrode and a common electrode are short-circuited at a certain point, a dark spot is generated in an entire pixel unit, resulting in poor display of a product.

Therefore, it is imperative to provide an array substrate and a display panel to overcome the aforementioned problem.

### SUMMARY OF INVENTION

The present application provides an array substrate and a display panel to overcome the problem of poor performance of a pixel unit caused by a short circuit between a pixel electrode and a common electrode at a certain point in the pixel unit.

In order to overcome the aforementioned problem, the present application provides a technical solution as follows:

In one aspect of the present application, the present application provides an array substrate, comprising a plurality of pixel units arranged in an array, wherein each of the pixel units comprises a first pixel driving circuit, a second pixel driving circuit, and a first transparent electrode configured to drive rotation of liquid crystal molecules, and wherein the first transparent electrode comprises a first electrode trace and a second electrode trace electrically insulated from each other; wherein the first pixel driving circuit is electrically connected to the first electrode trace, and the second pixel driving circuit is electrically connected to the second electrode trace

In an embodiment of the present application, the first electrode trace comprises a first main line and a first connecting line disposed at an end of the first main line, and the second electrode trace comprises a second main line and a second connecting line disposed at an end of the second main line, and wherein the first main line is electrically connected to the first pixel driving circuit through the first connecting line, and the second main line is electrically connected to the second pixel driving circuit through the second connecting line.

In an embodiment of the present application, the first electrode trace and the second electrode trace are alternately arranged.

In an embodiment of the present application, the first electrode trace is located at a side of the second electrode trace.

In an embodiment of the present application, the first pixel driving circuit comprises at least a first thin-film transistor, and the second pixel driving circuit comprises at least a second thin-film transistor, and wherein the first thin-film transistor and the second thin-film transistor are disposed at two sides of the first transparent electrode, respectively

In an embodiment of the present application, the present application further comprises a driving circuit configured to provide a row driving scan signal, and wherein the first driving pixel circuit and the second driving pixel circuit are connected to a same row driving scan signal line.

In an embodiment of the present application, the array substrate comprises a substrate; a thin-film transistor array disposed on the substrate, wherein the thin-film transistor array comprises a first thin-film transistor and a second thin-film transistor; a planarization layer disposed on the thin-film transistor array; a second transparent electrode layer disposed on the planarization layer; an interlayer dielectric layer disposed on the second transparent electrode layer; and a first transparent electrode layer disposed on the interlayer dielectric layer, wherein the first transparent electrode layer comprises the first transparent electrode; wherein the first electrode trace is electrically connected to a first drain of the first thin-film transistor thought a first via hole, and the second electrode trace is electrically connected to a second drain of the second thin-film transistor thought a second via hole.

In an embodiment of the present application, each of the first via hole and the second via hole extends through the interlayer dielectric layer and the planarization layer.

In an embodiment of the present application, number of the first electrode trace is the same as number of the second electrode trace.

In an embodiment of the present application, the pixel units each are one of a red pixel unit, a green pixel unit, and a blue pixel unit.

In another aspect of the present application, the present application further provides a display panel, comprising a color film substrate, an array substrate, and a liquid crystal layer disposed between the color film substrate and the array substrate; wherein the array substrate comprises a plurality of pixel units arranged in an array, each of the pixel units comprises a first pixel driving circuit, a second pixel driving circuit, and a first transparent electrode configured to drive rotation of liquid crystal molecules, and wherein the first transparent electrode comprises a first electrode trace and a second electrode trace electrically insulated from each other; wherein the first pixel driving circuit is electrically connected to the first electrode trace, and the second pixel driving circuit is electrically connected to the second electrode trace.

In an embodiment of the present application, the first electrode trace comprises a first main line and a first connecting line disposed at an end of the first main line, and the second electrode trace comprises a second main line and a second connecting line disposed at an end of the second main line, and wherein the first main line is electrically connected to the first pixel driving circuit through the first connecting line, and the second main line is electrically connected to the second pixel driving circuit through the second connecting line.

In an embodiment of the present application, the first electrode trace and the second electrode trace are alternately arranged.

In an embodiment of the present application, the first electrode trace is located at a side of the second electrode trace.

In an embodiment of the present application, the first pixel driving circuit comprises at least a first thin-film transistor, and the second pixel driving circuit comprises at least a second thin-film transistor; wherein the first thin-film transistor and the second thin-film transistor are disposed at two sides of the first transparent electrode, respectively.

In an embodiment of the present application, the display panel further comprises a driving circuit configured to provide a row driving scan signal, and wherein the first driving pixel circuit and the second driving pixel circuit are connected to a same row driving scan signal line.

In an embodiment of the present application, the array substrate comprises a substrate; a thin-film transistor array disposed on the substrate, wherein the thin-film transistor array comprises a first thin-film transistor and a second thin-film transistor; a planarization layer disposed on the thin-film transistor array; a second transparent electrode layer disposed on the planarization layer; an interlayer dielectric layer disposed on the second transparent electrode layer; and a first transparent electrode layer disposed on the interlayer dielectric layer, wherein the first transparent electrode layer comprises the first transparent electrode; wherein the first electrode trace is electrically connected to a first drain of the first thin-film transistor thought a first via hole, and the second electrode trace is electrically connected to a second drain of the second thin-film transistor thought a second via hole.

In an embodiment of the present application, each of the first via hole and the second via hole extends through the interlayer dielectric layer and the planarization layer.

In an embodiment of the present application, number of the first electrode trace is the same as number of the second electrode trace.

In an embodiment of the present application, the pixel units each are one of a red pixel unit, a green pixel unit, and a blue pixel unit.

The present application has advantageous effects as follows: in the present application, a pixel electrode is divided into two sets of signal traces, and the two sets of signal traces are controlled by different pixel driving circuits. When one set of the signal traces is short-circuited, the other set will still work normally, thereby increasing a yield of the product.

### BRIEF DESCRIPTION OF DRAWINGS

To better illustrate embodiments or technical solutions in the prior art, a brief description of the drawings used in the embodiments or the prior art description will be given below. Obviously, the accompanying drawings in the following description merely show some embodiments of the present invention, and a person skilled in the art may still derive other drawings from these accompanying drawings without creative efforts.

FIG. 1 is a schematic structural view of an array substrate in accordance with a first embodiment of the present application.

FIG. 2 is a schematic structural view of a pixel unit in accordance with a second embodiment of the present application.

FIG. 3 is a schematic structural view of an array substrate in accordance with a third embodiment of the present application.

### DESCRIPTION OF PREFERRED EMBODIMENTS

The following embodiments are referring to the accompanying drawings for exemplifying specific implementable embodiments of the present disclosure. Furthermore, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, elements with similar structures are labeled with like reference numerals.

The present application provides an array substrate and a display panel to overcome the problem of poor performance of a pixel unit caused by a short circuit between a pixel electrode and a common electrode at a certain point in the pixel unit.

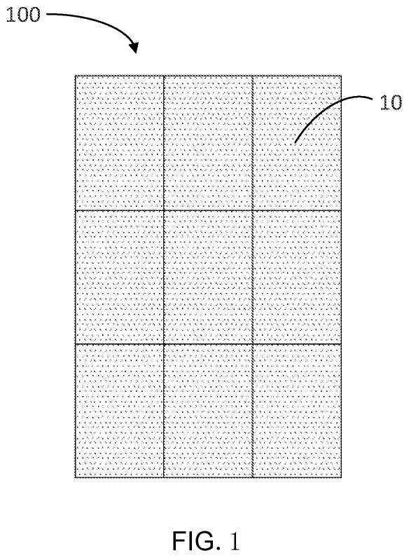

Please refer to FIG. 1 showing a schematic structural view of an array substrate 100 in accordance with a first embodiment of the present application.

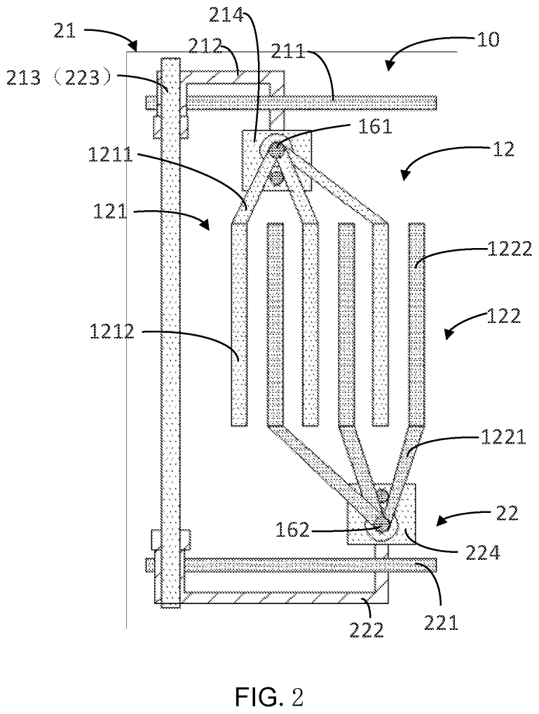

Please refer to FIG. 2 showing a schematic structural view of a pixel unit 10 in accordance with a second embodiment of the present application.

In one aspect of the present application, the present application provides an array substrate 100. The array substrate 100 includes a plurality of pixel units 10 arranged in an array.

In one embodiment of the present application, the pixel units 10 each are one of a red pixel unit, a green pixel unit, and a blue pixel unit.

Each of the pixel units 10 includes a first pixel driving circuit 111, a second pixel driving circuit 112, and a first transparent electrode 12 configured to drive rotation of liquid crystal molecules. The first transparent electrode 12 includes a first electrode trace 121 and a second electrode trace 122 electrically insulated from each other.

The array substrate 100 utilize semiconductor devices such as a thin-film transistor as a switching element for the pixel units 10to receive pixel data. Differences from a conventional pixel unit configured with only a pixel driving circuit lie in that the present application utilizes the pixel units 10 each are configured with two pixel driving circuits, wherein one of pixel electrodes (i.e. the first transparent electrode 12 of the present application) is divided to include the first electrode trace 121 and the second electrode trace 122 to operate, respectively, thereby to prevent a situation that a dark spot occurred in the pixel units 10 because of a short circuit resulted from a certain electrode line.

The first pixel driving circuit 111 is electrically connected to the first electrode trace 121, and the second pixel driving circuit 112 is electrically connected to the second electrode trace 122.

In one embodiment, the first pixel driving circuit 111 includes at least a first thin-film transistor 21, and the second pixel driving circuit 112 includes at least a second thin-film transistor 22, and wherein the first thin-film transistor 21 and the second thin-film transistor 22 are disposed at two sides of the first transparent electrode, respectively. In this manner, the first thin-film transistor 21 and the second thin-film transistor 22 can be prevented from mutual interference.

In one embodiment, the first pixel driving circuit 111 includes a first thin-film transistor 21, and the second pixel driving circuit 112 includes a second thin-film transistor 22.

In one embodiment, the first transparent electrode 12 is not limited to be divided into only the first electrode trace 121 and the second electrode trace 122, but also n kinds of electrode traces (n is a positive integer not less than 2), wherein each of the electrode traces is configured with a corresponding separate pixel driving circuit, thereby to prevent a situation that a dark spot occurred in the pixel units 10 because of a short circuit resulted from a certain electrode line.

Since division of the first transparent electrode 12 into two electrode traces facilitates arrangement of pixel driving circuits, and avoids complicated wiring of a product caused by excessive pixel driving circuits, the following, therefore, is mainly explained by one pixel electrode divided into two electrode traces as an example.

In one embodiment, lines of the first electrode trace 121 are electrically connected to each other, and lines of the second electrode trace 122 are electrically connected to each other. That is, the first electrode traces 121 and the second electrode traces 122 are assigned to different signal circuits, thereby preventing one of the first and second electrode traces 121 and 122 functioning abnormally from interfering with the other one.

In one embodiment, the first electrode trace 121 includes a first main line 1212 and a first connecting line 1211 disposed at an end of the first main line 1212. The second electrode trace 122 includes a second main line 1222 and a second connecting line 1221 disposed at an end of the second main line 1222, wherein the first main line 1212 is electrically connected to the first pixel driving circuit 111 through the first connecting line 1211, and the second main line 1222 is electrically connected to the second pixel driving circuit 112 through the second connecting line 1221.

In one embodiment, the first main line 1212 and the second main line 1222 are arranged in a first direction, and the first direction is parallel to a wiring direction of scan lines in the array substrate 100.

In one embodiment, the first electrode trace 121 and the second electrode trace 122 are identical in shape.

In one embodiment, the first main line 1212 and the second main line 1222 each has, but not limited to, a wave-like shape, a fold-line shape, and an elongated shape. Shapes of the first electrode traces 121 and the second electrode traces 122 can be varied according to actual needs.

In one embodiment, main lines (including the first main line 1212 and the second main line 1222) of the first transparent electrode 12 are spaced away from each other at a same pitch.

In one embodiment, main lines (including the first main line 1212 and the second main line 1222) of the first transparent electrode 12 are spaced away from each other at a different pitch.

In one embodiment, the first electrode trace 121 and the second electrode trace 122 are alternately arranged. By setting the first electrode trace 121 and the second electrode trace 122 to be alternately arranged, control performance on liquid crystal deflection by the first electrode trace 121 or the second electrode trace 122 can be improved.

In one embodiment, the first electrode trace 121 is located at a side of the second electrode trace 122. That is, the first electrode trace 121 and the second electrode trace 122 are located at different areas in the pixel unit 10, thereby to avoid giving rise to a considerable increase in difficulty in related manufacturing processes due to complicated arrangement of electrode traces in the array substrate 100.

In one embodiment, the array substrate 100 is formed by using gate driver on array (GOA) technology.

In one embodiment, the array substrate 100 further includes a driving circuit configured to provide a row driving scan signal, wherein the first driving pixel circuit 111 and the second driving pixel circuit 112 are connected to a same row driving scan signal line.

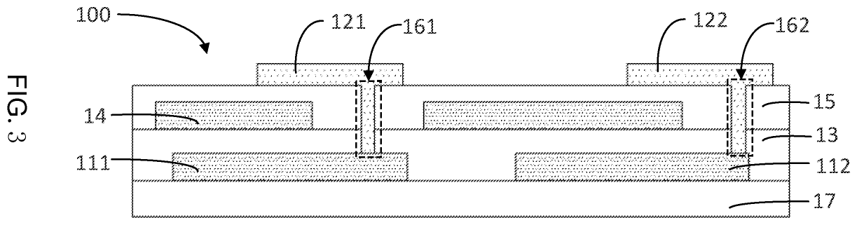

Please refer to FIG. 3 showing a schematic structural view of an array substrate 100 in accordance with a third embodiment of the present application.

In one embodiment, the array substrate 100 includes a substrate 17, a thin-film transistor array, a planarization layer 13, a second transparent electrode layer 14, an interlayer dielectric layer 15, and a first transparent electrode layer in sequence.

In one embodiment, the substrate 17 is one of a flexible substrate and a rigid substrate.

The thin-film transistor array disposed on the substrate 17 includes a first thin-film transistor 21 and a second thin-film transistor 22.

In one embodiment, the first thin-film transistor 21 includes a first active layer 212, a first gate 211, a first source 213, and a first drain 214.

In one embodiment, the second thin-film transistor 22 includes a second active layer 222, a second gate 221, a second source 223, and a second drain 224.

In one embodiment, the first source 213 (214) of the first thin-film transistor 21 is shared with the second thin-film transistor 22 such that data signals received by the first electrode trace 121 and the second electrode trace 122 are the same.

The first transparent electrode layer includes a plurality of first transparent electrodes 12, and each of the first transparent electrodes 12 belongs to one of the pixel units 10.

In one embodiment, the first electrode trace and the second electrode trace are electrically insulated from each other through the interlayer dielectric layer 15. In the current structure, the interlayer dielectric layer 15 is relatively thin and a break point is likely to occur, causing the first transparent electrode layer and the second electrode layer to be short-circuited. The present application can effectively overcome the above-mentioned problem.

In one embodiment, the first electrode trace 121 is electrically connected to the first drain 214 of the first thin-film transistor 21 thought a first via hole 161, and the second electrode trace 122 is electrically connected to a second drain 224 of the second thin-film transistor 22 thought a second via hole 162, wherein the first source 213 of the first thin-film transistor 21 is shared with the second source 223 of the second thin-film transistor 22 such that the first electrode trace 121 and the second electrode trace 122 receive the same data signal.

In one embodiment, each of the first via hole 161 and the second via hole 162 extends through the interlayer dielectric layer 15 and the planarization layer 13.

In one embodiment, number of the first electrode trace 121 is not the same as number of the second electrode trace 122.

In one embodiment, number of the first electrode trace 121 is the same as number of the second electrode trace 122.

According to another aspect of the present application, the present application further includes a display panel including a color film substrate, an array substrate 100, and a liquid crystal layer disposed between the color film substrate and the array substrate 100.

The array substrate 100 includes a plurality of pixel units 10 arranged in an array. Each of the pixel units 10 includes a first pixel driving circuit 111, a second pixel driving circuit 112, and a first transparent electrode 12 configured to drive rotation of liquid crystal molecules. The first transparent electrode 12 includes a first electrode trace 121 and a second electrode trace 122 electrically insulated from each other, wherein the first pixel driving circuit 111 is electrically connected to the first electrode trace 121, and the second pixel driving circuit 112 is electrically connected to the second electrode trace 122.

The present application has advantageous effects as follows: in the present application, a pixel electrode is divided into two sets of signal traces, and the two sets of signal traces are controlled by different pixel driving circuits. When one set of the signal traces is short-circuited, the other set will still work normally, thereby increasing a yield of the product.

Accordingly, although the present invention has been disclosed as a preferred embodiment, it is not intended to limit the present invention. Those skilled in the art without departing from the spirit and scope of the present invention may make various changes or modifications, and thus the scope of the present invention should be after the appended claims and their equivalents.

What is claimed is:

1. An array substrate, comprising:
a plurality of pixel units arranged in an array, wherein each of the pixel units comprises a first pixel driving circuit, a second pixel driving circuit, and a first transparent electrode configured to drive rotation of liquid crystal molecules, and wherein the first transparent electrode comprises a first electrode trace and a second electrode trace electrically insulated from each other;
wherein the first pixel driving circuit is electrically connected to the first electrode trace, and the second pixel driving circuit is electrically connected to the second electrode trace.

2. The array substrate of claim 1, wherein the first electrode trace comprises a first main line and a first connecting line disposed at an end of the first main line, and the second electrode trace comprises a second main line and a second connecting line disposed at an end of the second main line, and wherein the first main line is electrically connected to the first pixel driving circuit through the first connecting line, and the second main line is electrically connected to the second pixel driving circuit through the second connecting line.

3. The array substrate of claim 1, wherein the first electrode trace and the second electrode trace are alternately arranged.

4. The array substrate of claim 1, wherein the first electrode trace is located at a side of the second electrode trace.

5. The array substrate of claim 1, wherein the first pixel driving circuit comprises at least a first thin-film transistor, and the second pixel driving circuit comprises at least a second thin-film transistor, and wherein the first thin-film transistor and the second thin-film transistor are disposed at two sides of the first transparent electrode, respectively.

6. The array substrate of claim 1, further comprising a driving circuit configured to provide a row driving scan signal, and wherein the first driving pixel circuit and the second driving pixel circuit are connected to a same row driving scan signal line.

7. The array substrate of claim 5, further comprising:
a substrate;
a thin-film transistor array disposed on the substrate, wherein the thin-film transistor array comprises a first thin-film transistor and a second thin-film transistor;
a planarization layer disposed on the thin-film transistor array;
a second transparent electrode layer disposed on the planarization layer;
an interlayer dielectric layer disposed on the second transparent electrode layer; and
a first transparent electrode layer disposed on the interlayer dielectric layer, wherein the first transparent electrode layer comprises the first transparent electrode;
wherein the first electrode trace is electrically connected to a first drain of the first thin-film transistor thought a first via hole, and the second electrode trace is electrically connected to a second drain of the second thin-film transistor thought a second via hole.

8. The array substrate of claim 7, wherein each of the first via hole and the second via hole extends through the interlayer dielectric layer and the planarization layer.

9. The array substrate of claim 1, wherein number of the first electrode trace is the same as number of the second electrode trace.

10. The array substrate of claim 1, wherein the pixel units each are one of a red pixel unit, a green pixel unit, and a blue pixel unit.

11. A display panel, comprising a color film substrate, an array substrate, and a liquid crystal layer disposed between the color film substrate and the array substrate;
wherein the array substrate comprises a plurality of pixel units arranged in an array, each of the pixel units comprises a first pixel driving circuit, a second pixel driving circuit, and a first transparent electrode configured to drive rotation of liquid crystal molecules, and wherein the first transparent electrode comprises a first electrode trace and a second electrode trace electrically insulated from each other;
wherein the first pixel driving circuit is electrically connected to the first electrode trace, and the second pixel driving circuit is electrically connected to the second electrode trace.

12. The display panel of claim 11,wherein the first electrode trace comprises a first main line and a first connecting line disposed at an end of the first main line, and the second electrode trace comprises a second main line and a second connecting line disposed at an end of the second main line, and wherein the first main line is electrically connected to the first pixel driving circuit through the first connecting line, and the second main line is electrically connected to the second pixel driving circuit through the second connecting line.

13. The display panel of claim 11, wherein the first electrode trace and the second electrode trace are alternately arranged.

14. The display panel of claim 11, wherein the first electrode trace is located at a side of the second electrode trace.

15. The display panel of claim 11, wherein the first pixel driving circuit comprises at least a first thin-film transistor, and the second pixel driving circuit comprises at least a second thin-film transistor; wherein the first thin-film transistor and the second thin-film transistor are disposed at two sides of the first transparent electrode, respectively.

16. The display panel of claim 11, further comprising a driving circuit configured to provide a row driving scan signal, and wherein the first driving pixel circuit and the second driving pixel circuit are connected to a same row driving scan signal line.

17. The display panel of claim 15, further comprising:
a substrate;
a thin-film transistor array disposed on the substrate, wherein the thin-film transistor array comprises a first thin-film transistor and a second thin-film transistor;
a planarization layer disposed on the thin-film transistor array;
a second transparent electrode layer disposed on the planarization layer;
an interlayer dielectric layer disposed on the second transparent electrode layer; and
a first transparent electrode layer disposed on the interlayer dielectric layer, wherein the first transparent electrode layer comprises the first transparent electrode;
wherein the first electrode trace is electrically connected to a first drain of the first thin-film transistor thought a first via hole, and the second electrode trace is electrically connected to a second drain of the second thin-film transistor thought a second via hole.

18. The display panel of claim 17, wherein each of the first via hole and the second via hole extends through the interlayer dielectric layer and the planarization layer.

19. The display panel of claim 11, wherein number of the first electrode trace is the same as number of the second electrode trace.

20. The display panel of claim 11, wherein the pixel units each are one of a red pixel unit, a green pixel unit, and a blue pixel unit.
